(19) United States
(12) Patent Application Publication
(10) Pub. No.: US 2025/0007319 A1
(43) Pub. Date: Jan. 2, 2025

(54) HIGH-PRESSURE CLEANING MACHINE USING BOTH ALTERNATING CURRENT AND DIRECT CURRENT

(71) Applicant: LUTIAN MACHINERY CO., LTD., TAIZHOU (CN)

(72) Inventors: Changguo LUO, TAIZHOU (CN); Yubo CHEN, TAIZHOU (CN)

(21) Appl. No.: 18/710,422

(22) PCT Filed: Dec. 8, 2021
(86) PCT No.: PCT/CN2021/136600

§ 371 Date: May 15, 2024

(30) Foreign Application Priority Data
Nov. 29, 2021 (CN) 202111433907.3

(51) Int. Cl. H02J 7/02; B08B 3/02; B08B 13/00

(52) U.S. Cl. CPC H02J 7/02; B08B 3/02; B08B 13/00

(57) ABSTRACT

The invention relates to a high-pressure cleaning machine using both alternating current and direct current, comprising: an alternating-current channel, an input end of which is connected to an alternating-current power supply, an output end of which is connected to an alternating-current electric motor; a direct-current channel, an input end of which is connected to a battery pack, and an output end of which is connected to the direct-current electric motor; a charging channel, an input end of which is connected to the alternating-current power supply, an output end of which is connected to the battery pack. The alternating-current electric motor and the direct-current electric motor share a high-pressure pump, and an output end of the high-pressure pump is connected to a high-pressure pipe, a high-pressure gun and a nozzle.

### BACKGROUND OF THE INVENTION

### 1. Field of the Invention

The present invention relates to the field of clean technology, particular to a high-pressure cleaning machine using both alternating current and direct current.

### 2. Description of the Related Art

At present, the power supply mode of the cleaning machine usually includes three categories, the first one uses alternating-current power supply, the second one uses direct-current power supply, and the third one uses AC/DC general power supply. For the cleaning machine powered by alternating-current power supply, its range of motion is limited by the position of the power socket and the length of the wire, and it is inconvenient to use; for the cleaning machine powered by direct-current power supply, in order to ensure the lightness of moving, the battery pack that it carries is often reduced in the design process, so the capacity of the battery pack is also reduced accordingly, which will lead to the shortening of the working time of the cleaning machine, and even the situation that the rated voltage of the starting cleaning machine cannot be reached. There are many kinds of battery packs on the market, and there are many types of corresponding chargers, the versatility of the two is low and these two is prone to be confused when used together. Therefore, a cleaning machine with AC/DC power supply together is the best solution.

However, the design of the cleaning machine of AC/DC power supply in the prior art is not humane enough, the charging of its battery pack needs to manually plug the patch cord into the external power supply, and the plug part is easy to loosen after multiple plugging, and can only be used in one of the direct-current power supply and the alternating-current power supply, and these two cannot cooperate to supply power to the cleaning machine simultaneously, and the operation convenience and safety of the cleaning machine are greatly reduced.

### SUMMARY OF THE INVENTION

According to the existing problems in the prior art, a high-pressure cleaning machine using both alternating current and direct current is provided, which aims to solve the issue that the cleaning machine in the prior art cannot be shared by alternating-current power and direct-current power.

The technical solution is as follows:
a high-pressure cleaning machine using both alternating current and direct current, comprising an alternating-current channel, a direct-current channel, a charging channel, which are independent of each other,
an input end of the alternating-current channel is connected to an alternating-current power plug, the output end of the alternating-current channel is connected to an alternating-current electric motor;
an input end of the direct-current channel is connected to a battery pack, an output end of the direct-current channel is connected to a direct-current electric motor;
an input end of the charging channel is connected to the alternating-current power plug, an output end of the charging channel is connected to the battery pack;
the alternating-current electric motor and the direct-current electric motor share a high-pressure pump, a water outlet of the high-pressure pump is connected to a high-pressure pipe, a high-pressure gun and a nozzle.

Preferably, the alternating-current power plug of the alternating-current channel can be inserted into an alternating-current power socket to obtain electric energy, and a power line corresponding to the alternating-current power plug is connected to a first switch, an alternating-current drive wire, an first micro switch successively followed by connecting the alternating-current electric motor, and the alternating-current channel is configured for controlling the operation of the alternating-current electric motor.

Preferably, the direct-current channel is provided with electric energy by the battery pack, and a control board, a second switch, a direct-current drive wire, a second micro switch are successively arranged between the battery pack and the direct-current electric motor, and the operation of the direct-current electric motor is controlled.

Preferably, the alternating-current electric motor and the direct-current electric motor are independent of each other, or
the alternating-current electric motor and the direct-current electric motor are a composition motor which is combined by each other, and both the number of the alternating-current electric motor and the number of the direct-current electric motor are greater than or equal to one.

Preferably, the first switch and the second switch are independent of each other, or
the first switch and the second switch are a multi-position switch which is combined by each other.

Preferably, the first micro switch and the second micro switch are independent of each other, or
the first micro switch and the second micro switch are a multi-position micro switch which is combined by each other.

Preferably, the charging channel is provided with a rectifier transformer, an input end of the charging channel is connected to an alternating-current power supply through the power line and the alternating-current power plug to obtain electric energy, after current is rectified and transformed by the rectifier transformer, an output end of the charging channel is connected to the battery pack through the control board, so as to charge the battery pack, and the number of the battery pack is greater than or equal to one.

Preferably, the alternating-current electric motor and the direct-current electric motor are jointly connected and drive the high-pressure pump, the high-pressure pump has a water inlet and the water outlet, the water inlet can be connected to a water source, and the water outlet is connected to the high-pressure pipe followed by connecting the high-pressure gun and the nozzle;
the operation of the direct-current electric motor or the alternating-current electric motor drives the high-pressure pump to reciprocate to pressurize water flow, and a low-pressure water flow enters through the water inlet, after the low-pressure water is pressurized by the high-pressure pump, it passes through the high-pressure pipe and the high-pressure gun successively, and a high-pressure water flow is sprayed out from the nozzle.

Preferably, further comprising:
a machine shell, which provides fixing and protection functions to the battery pack, the control board, the first switch, the second switch, the first micro switch, the second micro switch, the direct-current electric motor, and the alternating-current electric motor.

Preferably, the high-pressure pump is a reciprocating plunger pump, and the number of the high-pressure pump is greater than or equal to one.

The beneficial effects of the present invention are that: if there is alternating-current mains electricity, a cleaning machine can be driven by using an alternating-current power supply, and the alternating-current mains electricity can also charge a battery pack after being rectified and transformed by means of the charging channel, such that charging can be performed during use, thereby improving convenience, if there is no alternating-current mains electricity, the cleaning machine can be driven by the battery pack, so as to get rid of the constraint of an electric wire, thereby greatly increasing the usage places of the cleaning machine and greatly expanding the usage range thereof, and meeting more usage requirements, and it is possible to select only one of an alternating-current mode or a direct-current mode for operation, and it is also possible to operate under an alternating current and a direct current at the same time.

### BRIEF DESCRIPTION OF THE DRAWINGS

Refer to the accompanying drawings to more fully describe embodiments of the present invention. However, the accompanying drawings are used only for illustration and do not constitute a limitation of the scope of the present invention.

FIG. 1 shows a schematic diagram of the structure of a high-pressure cleaning machine using both alternating current and direct current of the present invention.

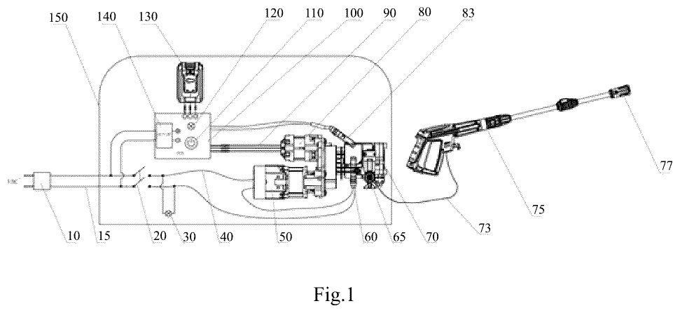

### DETAILED DESCRIPTION

The technical solutions in the embodiments of the present invention will be clearly and completely described below in conjunction with the accompanying drawings in the embodiments of the present invention, and it is clear that the described embodiments are only some embodiments of the present invention, not all embodiments. Based on the embodiments in the present invention, all other embodiments obtained by a person skilled in the art without creative labor fall within the scope of protection of the present invention.

It should be noted that, without conflict, the embodiments in the present invention and the features in the embodiments may be combined with each other.

The present invention is further described below in conjunction with the accompanying drawings and specific embodiments, but is not used as a limitation of the present invention.

In an embodiment, there is provided a high-pressure cleaning machine using both alternating current and direct current, comprising an alternating-current channel, a direct-current channel, a charging channel, which are independent of each other;
an input end of the alternating-current channel is connected to an alternating-current power plug 10, the output end of the alternating-current channel is connected to an alternating-current electric motor 50;
an input end of the direct-current channel is connected to a battery pack 130, an output end of the direct-current channel is connected to a direct-current electric motor 80;
an input end of the charging channel is connected to the alternating-current power plug 10, an output end of the charging channel is connected to the battery pack 130;
the alternating-current electric motor 50 and the direct-current electric motor 80 share a high-pressure pump 70, a water outlet of the high-pressure pump 70 is connected to a high-pressure pipe 73, a high-pressure gun 75 and a nozzle 77.

Specifically, the high-pressure pump 70 is a reciprocating plunger pump, and the number of the high-pressure pump 70 is greater than or equal to one.

In a preferred embodiment, the alternating-current power plug of the alternating-current channel can be inserted into an alternating-current power socket to obtain electric energy, and a power line 15 corresponding to alternating-current power plug 10 is connected to a first switch 20, an alternating-current drive wire 40, an first micro switch 60 successively followed by connecting the alternating-current electric motor 50, and the alternating-current channel is configured for controlling the operation of the alternating-current electric motor.

In a preferred embodiment, the alternating-current power plug of the alternating-current channel can be inserted into an alternating-current power socket to obtain electric energy, and a power line corresponding to the alternating-current power plug 10 is connected to a first switch 20, an alternating-current drive wire 40, an first micro switch 60 successively followed by connecting the alternating-current electric motor 50, and the alternating-current channel is configured for controlling the operation of the alternating-current electric motor 50.

In a preferred embodiment, the alternating-current electric motor 50 and the direct-current electric motor 80 are independent of each other, or the alternating-current electric motor 50 and the direct-current electric motor 80 are a composition motor which is combined by each other, and both the number of the alternating-current electric motor 50 and the number of the direct-current electric motor 80 are greater than or equal to one.

In a preferred embodiment, the first switch 20 and the second switch 110 are independent of each other, or the first switch 20 and the second switch 110 are a multi-position switch which is combined by each other.

Specifically, the alternating-current drive wire 40 is also provided with an alternating-current indicator light 30, which is used for prompting the alternating-current current is supplying power to the alternating-current electric motor 50.

In a preferred embodiment, the first micro switch 60 and the second micro switch 83 are independent of each other, or
the first micro switch 60 and the second micro switch 83 are a multi-position micro switch which is combined by each other.

In a preferred embodiment, the charging channel is provided with a rectifier transformer 140, an input end of the charging channel is connected to an alternating-current power supply through the power line 15 and the alternating-current power plug 10 to obtain electric energy, after current is rectified and transformed by the rectifier transformer 140, an output end of the charging channel is connected to the battery pack 130 through the control board 100, so as to charge the battery pack 130, and the number of the battery pack 130 is greater than or equal to one.

In a preferred embodiment, the alternating-current electric motor 50 and the direct-current electric motor 80 are jointly connected and drive the high-pressure pump 70, the high-pressure pump 70 has a water inlet and the water outlet, the water inlet can be connected to a water source, and the water outlet is connected to the high-pressure pipe 73 followed by connecting the high-pressure gun 75 and the nozzle 77;
the operation of the direct-current electric motor 80 or the alternating-current electric motor 50 drives the high-pressure pump 70 to reciprocate to pressurize water flow, and a low-pressure water flow enters through the water inlet, after the low-pressure water is pressurized by the high-pressure pump 70, it passes through the high-pressure pipe 73 and the high-pressure gun 75 successively, and a high-pressure water flow is sprayed out from the nozzle 77.

In a preferred embodiment, further comprising:
a machine shell 150, which provides fixing and protection functions to the battery pack 130, the control board 100, the first switch 20, the second switch 110, the first micro switch 60, the second micro switch 83, the direct-current electric motor 80, and the alternating-current electric motor 50.

Specifically, the control board 100 is also provided with a direct-current indicator light 120, which is used for prompting the battery pack 130 is supplying power to the direct-current electric motor 80.

Specifically, the alternating-current power plug 10 and the corresponding power line 15 are partially exposed outside the machine shell 150.

Specifically, the first switch 20, the second switch 110, the first micro switch 60, the second micro switch 83 are all mounted on the machine shell 150.

The use of the high-pressure cleaning machine using both alternating current and direct current in this embodiment is as follows:
if there is alternating-current mains electricity, the user connects the power line 15 to the alternating-current power plug 10, the alternating-current power is input into the high-pressure cleaning machine using both alternating current and direct current in this embodiment. In the meantime, the first switch 20 is opened, the alternating-current power is directly supplied to the alternating-current electric motor 50, and the alternating-current electric motor 50 drives the high-pressure pump 70 to reciprocate, the water inlet of the high-pressure pump 70 is connected to the water source, and a low-pressure water flow enters through the water inlet and passes through the high-pressure pipe 73 and the high-pressure gun 75 successively, after that, a high-pressure water flow is sprayed out from the nozzle 77 for washing and cleaning the object.

In another preferred embodiment, if the alternating current is converted into direct current through the rectifier transformer module 140, this direct current is used to charge the battery pack 130.

When the cleaning machine is carried to the place of the open field, there is no condition that can obtain external alternating-current mains power at this moment. If the second switch 110 is turned on, and the battery pack 130 directly supplies power to the direct-current electric motor 80, then the direct-current electric motor 80 drives the high-pressure pump 70 to reciprocate, the water inlet of the high-pressure pump 70 is connected to the water source, and a low-pressure water flow enters through the water inlet and passes through the high-pressure pipe 73 and the high-pressure gun 75 successively, after that, a high-pressure water flow is sprayed out from the nozzle 77 for washing and cleaning the object.

The beneficial effects of the present invention are that: if there is alternating-current mains electricity, a cleaning machine can be driven by using an alternating-current power supply, and the alternating-current mains electricity can also charge a battery pack after being rectified and transformed by means of the charging channel, such that charging can be performed during use, thereby improving convenience, if there is no alternating-current mains electricity, the cleaning machine can be driven by the battery pack, so as to get rid of the constraint of an electric wire, thereby greatly increasing the usage places of the cleaning machine and greatly expanding the usage range thereof, and meeting more usage requirements, and it is possible to select only one of an alternating-current mode or a direct-current mode for operation, and it is also possible to operate under an alternating current and a direct current at the same time.

The above is only a preferred embodiment of the present invention, and does not intend to limit the embodiment and scope of protection of the present invention, and those skilled in the art should be able to realize that all solutions obtained by equivalent substitutions and obvious changes made by using the contents of the description and illustrations shall be included in the scope of protection of the present invention.

1. A high-pressure cleaning machine using both alternating current and direct current, comprising an alternating-current channel, a direct-current channel, a charging channel, which are independent of each other,
an input end of the alternating-current channel is connected to an alternating-current power plug, the output end of the alternating-current channel is connected to an alternating-current electric motor;
an input end of the direct-current channel is connected to a battery pack, an output end of the direct-current channel is connected to a direct-current electric motor;
an input end of the charging channel is connected to the alternating-current power plug, an output end of the charging channel is connected to the battery pack;
the alternating-current electric motor and the direct-current electric motor share a high-pressure pump, a water outlet of the high-pressure pump is connected to a high-pressure pipe, a high-pressure gun and a nozzle.

2. The high-pressure cleaning machine using both alternating current and direct current of claim 1, wherein the alternating-current power plug of the alternating-current channel can be inserted into an alternating-current power socket to obtain electric energy, and a power line corresponding to the alternating-current power plug is connected to a first switch, an alternating-current drive wire, an first micro switch successively followed by connecting the alternating-current electric motor, and the alternating-current channel is configured for controlling the operation of the alternating-current electric motor.

3. The high-pressure cleaning machine using both alternating current and direct current of claim 1, wherein the direct-current channel is provided with electric energy by the battery pack, and a control board, a second switch, a direct-current drive wire, a second micro switch are successively arranged between the battery pack and the direct-current electric motor, and the operation of the direct-current electric motor is controlled.

4. The high-pressure cleaning machine using both alternating current and direct current of claim 2, wherein the alternating-current electric motor and the direct-current electric motor are independent of each other, or
the alternating-current electric motor and the direct-current electric motor are a composition motor which is combined by each other, and both the number of the alternating-current electric motor and the number of the direct-current electric motor are greater than or equal to one.

5. The high-pressure cleaning machine using both alternating current and direct current of claim 2, wherein the first switch and the second switch are independent of each other, or
the first switch and the second switch are a multi-position switch which is combined by each other.

6. The high-pressure cleaning machine using both alternating current and direct current of claim 2, wherein the first micro switch and the second micro switch are independent of each other, or
the first micro switch and the second micro switch are a multi-position micro switch which is combined by each other.

7. The high-pressure cleaning machine using both alternating current and direct current of claim 3, wherein the charging channel is provided with a rectifier transformer, an input end of the charging channel is connected to an alternating-current power supply through the power line and the alternating-current power plug to obtain electric energy, after current is rectified and transformed by the rectifier transformer, an output end of the charging channel is connected to the battery pack through the control board, so as to charge the battery pack, and the number of the battery pack is greater than or equal to one.

8. The high-pressure cleaning machine using both alternating current and direct current of claim 1, wherein the alternating-current electric motor and the direct-current electric motor are jointly connected and drive the high-pressure pump, the high-pressure pump has a water inlet and the water outlet, the water inlet can be connected to a water source, and the water outlet is connected to the high-pressure pipe followed by connecting the high-pressure gun and the nozzle;
the operation of the direct-current electric motor or the alternating-current electric motor drives the high-pressure pump to reciprocate to pressurize water flow, and a low-pressure water flow enters through the water inlet, after the low-pressure water is pressurized by the high-pressure pump, it passes through the high-pressure pipe and the high-pressure gun successively, and a high-pressure water flow is sprayed out from the nozzle.

9. The high-pressure cleaning machine using both alternating current and direct current of claim 2, further comprising:
a machine shell, which provides fixing and protection functions to the battery pack, the control board, the first switch, the second switch, the first micro switch, the second micro switch, the direct-current electric motor, and the alternating-current electric motor.

10. The high-pressure cleaning machine using both alternating current and direct current of claim 1, wherein the high-pressure pump is a reciprocating plunger pump, and the number of the high-pressure pump is greater than or equal to one.

11. The high-pressure cleaning machine using both alternating current and direct current of claim 3, wherein the alternating-current electric motor and the direct-current electric motor are independent of each other, or
the alternating-current electric motor and the direct-current electric motor are a composition motor which is combined by each other, and both the number of the alternating-current electric motor and the number of the direct-current electric motor are greater than or equal to one.

12. The high-pressure cleaning machine using both alternating current and direct current of claim 3, wherein the first switch and the second switch are independent of each other, or
the first switch and the second switch are a multi-position switch which is combined by each other.

13. The high-pressure cleaning machine using both alternating current and direct current of claim 3, wherein the first micro switch and the second micro switch are independent of each other, or
the first micro switch and the second micro switch are a multi-position micro switch which is combined by each other.

14. The high-pressure cleaning machine using both alternating current and direct current of claim 3, further comprising:
a machine shell, which provides fixing and protection functions to the battery pack, the control board, the first switch, the second switch, the first micro switch, the second micro switch, the direct-current electric motor, and the alternating-current electric motor.
